(19) United States
(12) Patent Application Publication
(10) Pub. No.: US 2003/0187976 A1
(43) Pub. Date: Oct. 2, 2003

(54) Tracking users at a web server network

(76) Inventor: Jerry B. Decime, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/113,260

(22) Filed: Apr. 1, 2002

(51) Int. Cl. G06F 15/173

(52) U.S. Cl. 709/224; 709/238

(57) ABSTRACT

A method of tracking clients at a web server network comprises intercepting web page communications between a client computer and at least one web server within the network. A client tag is assigned to the client computer in association with each web page communication and stored within the web server network independent of the client computer and the at least one web server.

A web server network comprises at least one web server and a customer tracking system. The at least one web server is configured for producing a first web page in response to a first web page request by a client computer. The customer tracking system is disposed adjacent the web server and configured for intercepting the first web page request and the first web page for associating a client tag with the first web page and the client computer and storing the client tag within the web server network independent of a client computer.

### THE FIELD OF THE INVENTION

The present invention relates to web server networks and in particular to tracking users at web server networks.

### BACKGROUND OF THE INVENTION

Privacy and piracy on the Internet is a large concern for both Internet users and web site administrators. Many web sites attempt to strike a balance between tracking their customers to meet the customer's needs through customization while avoiding snooping on all of their customer's activities and private information. However, since some customers desire to share little or no information at all about their habits, demographics, and/or personal information, and since some web sites tend to overreach in gathering information about their customers, a great tension has arisen between web sites and Internet users regarding privacy.

This tension has boiled over on the subject of cookies. Cookies are small pieces of information about an Internet user that are sent from the web site to the Internet user's web browser for storage on the Internet user's computer. The web sites use the cookies to track the customers and gain personal information about the customers. Much to the dismay of the customers, cookies are usually created, and stored on the customer's computer, without the knowledge or consent of the customers. In response, a whole industry has blossomed for blocking, deleting, and/or filtering cookies. While eliminating cookies would appear to be entirely beneficial for customers, conscientious web sites lose a practical tool for legitimately tracking customers across many web servers within a single organizational network. Customer tracking allows the network to adapt and modify its web sites, web pages, and Internet presence to meet customers needs. Accordingly, the complete elimination of cookies ultimately thwarts the customer's use of the Internet while paralyzing the web sites attempts to satisfy customer demand.

Previous attempts by networks to solve the cookie-blocking problem have focused on developing a single application server environment containing a mechanism for tracking customers. This attempted solution requires each web server within a network to modify their programs to work in that single application server. Unfortunately, for larger networks of large corporations, this pathway does not work well due to both geographic diversity and product line diversity, and requires a great deal of time for the many web server programs that must be modified.

### SUMMARY OF THE INVENTION

The present invention is directed to tracking clients at a web server network. The method comprises intercepting web page communications between a client computer and at least one web server within the network. A client tag is assigned to the client computer in association with each web page communication and stored within the web server network independent of the client computer and the at least one web server.

The present invention is also directed to a web server network and comprises at least one web server and a customer tracking system. The at least one web server is configured for producing a first web page in response to a first web page request by a client computer. The customer tracking system is disposed adjacent the web server and configured for intercepting the first web page request and the first web page for associating a client tag with the first web page and the client computer and storing the client tag within the web server network independent of a client computer.

### BRIEF DESCRIPTION OF THE DRAWINGS

FIG. 1 is a block diagram of a system for tracking clients across a network, according to an embodiment of the present invention.

FIG. 2 is flow diagram of a method of tracking clients across a network, according to an embodiment of the present invention.

FIG. 3 is a block diagram of a communication interceptor utility, according to an embodiment of the present invention.

FIG. 4 is a block diagram of a server-side cookie manager, according to an embodiment of the present invention.

FIG. 5 is a block diagram of a server-side cookie database, according to an embodiment of the present invention.

FIG. 6 is flow diagram of a method of tracking clients across a network, according to an embodiment of the present invention.

FIG. 7 is a block diagram of a network page, according to an embodiment of the present invention.

FIG. 8 is a block diagram of a network page, according to an embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the present invention may be implemented in hardware via a microprocessor, programmable logic, or state machine, in firmware, or in software within a given device. In one aspect, at least a portion of the software programming is web-based and written in HTML, XML, Javascript, and JAVA programming languages, including links to graphical user interfaces, such as via windows-based operating system. The components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

Preferably, the user interfaces, such as a web browser, described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employ a graphical user interface windowing environment which presents the applications or documents in specially delineated areas of the display screen called “windows.” The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

A system and method of the present invention for tracking clients at a web server network permits tracking customers' use of one or more web servers within the network without storing the tracking information on a client computer of the customer, and operates independently of the particular architecture of the web server network. This tracking is accomplished by intercepting network page communications between the client computer and the web server that carries the request network page. Next, a client tag is created and associated with the client computer and intercepted network page communication. When the requested network page is returned to the client computer, every uniform resource locator (URL) in the returned network page includes the client tag attached at the end of the uniform resource locator string. With this tagging, any activation of a uniform resource locator in the network page necessarily results in the client tag being returned to the web server network with the activated uniform resource locator. Consequently, the web server network recognizes the network page request as originating from the client computer because of the client tag that forms a part of the activated uniform resource locator.

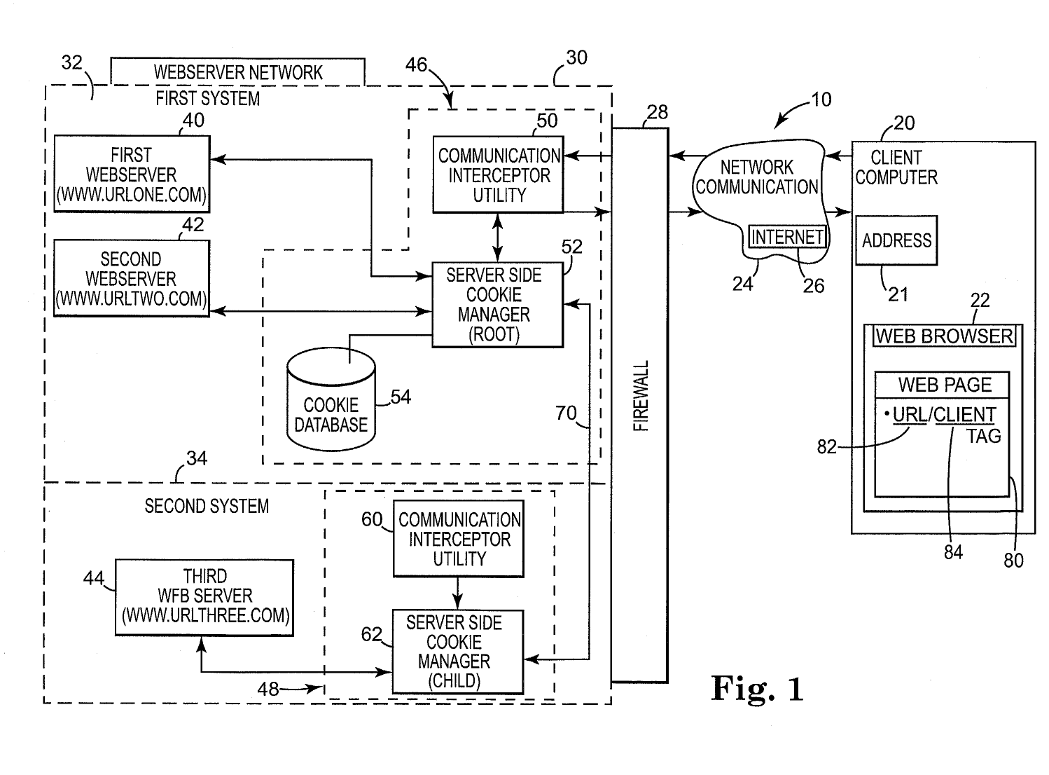

In one exemplary embodiment of the present invention, a system 10 for monitoring a network is illustrated in FIG. 1 generally at 10. As shown in FIG. 1, system 10 includes client computer 20 with address 21 and web browser 22, network communication link 24, firewall 28, and web server network 30. Web server network 30 includes first web server system 32 and second web server system 34.

First web server system 32 includes first web server 40, second web server 42, and first customer tracking system 46, which includes communication interceptor utility 50, server-side cookie manager 52, and server-side cookie database 54. Second web server system 34 includes third web server 44, and second customer tracking system 48, which includes communication interceptor utility 60 and second server-side cookie manager 62. Finally, port 70 provides a communication pathway or link between first customer tracking system 46 and second customer tracking system 48 to allow state information (i.e. web page session information about a customer) to be shared between the respective server-side cookie managers 50,60.

Client computer 20 is preferably configured as any computer or appliance capable of network page communications such as Internet use or world wide web browsing. For example, client computer 20 includes a mobile computing device such as a handheld or notebook computer, personal digital assistant, or mobile phone, as well as a desktop or stationary computing device, Internet appliance, etc. Client computer 20 includes client computer address 21 and is preferably recognized in network communications, such as Internet communications, by an Internet protocol (IP) address, such as 98.567.45.678. Of course, other communication and resource protocols are available and are optionally used for uniquely identifying client computer 20 to web server network 30.

Web browser 22 of client computer 20 displays web page 80, which lists an activatable hypertext link expressed as uniform resource locator (URL) 82 with selectively attached client tag 84. Upon activation of uniform resource locator 82, web browser 22 requests a web page from web server network 30 and displays the requested web page produced by web server network 30. Client tag 84 is an alphanumeric character string selectively appended to the end of uniform resource locator 82 and is produced as part of uniform resource locator 82 at the discretion of web server network 30 to track client computer 20, as will be more fully described herein.

Web browser 22 of client computer 20 preferably comprises an Internet browser such as Internet Explorer® or Netscape Navigator®, or other system for generating visual objects such as text, objects, and graphical user interface objects, that can be activated and deactivated with a pointing device. Web browser 22 preferably further comprises web browser software supported by any one of several computer system platforms such as Windows, Macintosh, Unix, Linux, and other platforms capable of executing web browser software that provides HTTP (Hyper Text Transfer Protocol) client functions and that renders HTML (Hyper Text Markup Language) files, as well as other communication protocols such as FTP (File Transfer Protocol) and SMTP (Standard Mail Transmission Protocol). However, client computer 20 optionally includes other client or terminal interfaces for communicating and computing with network 30.

Network communication link 24, as used herein, includes an Internet communication link (e.g., the Internet), an intranet communication link, or similar high-speed communication link. In one preferred embodiment, network communication link 24 includes an Internet communication link 26. Network communication link 24 permits communication between client computer 20 (including web browser 22) and web server network system 30.

Firewall 28 is a barrier preventing unauthorized general access into web server network 30 and permitting select channels of communication originated by web server network 30 to communicate with legitimate Internet users, such as client computer 20. With the method and system of the present invention, all network page communications within web server network 30 behind firewall 28 comprises the universe of network page communications on which the method and system of the present invention will operate to track users, such as client computer 20, accessing web servers 40-44 on web server network 30.

Web server network 30 preferably comprises a network configured for supplying documents via web servers 40-44 to provide client computer 20 with information on a particular topic or to carry out a transaction with client computer 20. For example, web server network 30 preferably includes a product support web site, supported by first, second and/or third web servers 40-44, devoted to providing a user information about a product and/or technical support through a compilation of web pages, and links to other web pages, displayed at client computer 20. The web page links direct client computer 20 back to web servers 40-44 of web server network 30 via uniform resource locators. Accordingly, each web server 40-44 of web server network 30 is represented by a uniform resource locator. For example, first web server 40 is identified on the Internet with its uniform resource locator, such as www.urlone.com, while second server 42 is also identified by its own uniform resource locator, such as www.urltwo.com. Finally, third web server 44 has its own uniform resource locator, www.urlthree.com, and is located within a second web server system 34 independent of first web server system 32.

As web server network 30 supplies information and conducts transactions with client computer 20, web server network 30 desires to track customers between multiple web servers 40-44 on network 30. Tracking customers allows seamless customized web browsing across the entire network 30. The customer benefits from faster, more accurate service as well as from web page customization that caters to the preferences of the customer at client computer 20. Accordingly, the system and method of the present invention includes customer tracking systems 46 and 48 for tracking customers at web server network 30 across diverse subnets within web server network 30, such as first web server system 32 and second web server system 34.

As shown in FIG. 1, customer tracking system 46 is disposed between firewall 28 and each web server 40,42 within web server network 30 while customer tracking system 48 is disposed between firewall 28 and web server 44 within web server network 30. First customer tracking system 46 includes communication interceptor utility 50, server-side cookie manager 52, and cookie database 54.

Communication interceptor utility 50 is equipped to detect, intercept and evaluate all web page communications through web server network 30. These communications include all web page requests made to web server network 30 by client computer 20 via uniform resource locator addresses from a web page of web server network 30, as well as all web pages being returned from web servers 40-44 to a requesting client computer 20.

Server-side cookie manager 52 cooperates with communication interceptor utility 50 to manipulate each web page communication between web server network 30 and client computer 20 bearing a uniform resource locator to associate a server-side cookie, e.g., client tag 84 (or other session management token) with client computer 20. This association is stored in cookie database 54 for access by each server-side cookie managers 52, 62. Client tag 84 is stored in cookie database 54 within web server network 30 independent of client computer 20 and independently of each web server 40-44.

Second customer tracking system 48, server-side cookie manager 62 and communication interceptor utility 60 with carry substantially the same features and attributes as first customer tracking system 46, except for link 70 which is provided as a common port for linking between customer tracking systems 46,48 and to database 54. Otherwise, second customer tracking system 48 functions within web server system 34 substantially the same way that first customer tracking system 46 functions within web server system 32. Second customer tracking system 48 operates independently of first customer tracking system 46 to track customers in web server system 34, except for sharing centrally stored state information, such as client tags 84 and client computer addresses 21 in cookie database 54, via link 70. However, this link 70 between respective server-side cookie managers 52,62 permits integrating customer tracking across entire web server network 30.

Dedicated port 70 maintains state information between web server systems 32 and 34 with their respective server side cookie managers 52,62. Dedicated port 70 joins web server systems 32 and 34, which can be separated by a country or continent or by diversity of content. First server side cookie manager 52 maintains data about each of web servers 40-44 of systems 32 and 34 for which it monitors network communications. When acting as a root server manager, first server side cookie manager 52 tracks the status of each web server 40-44 for recognizing whether to merely append a client tag 84 to an existing Dedicated port 70 maintains state information between web server systems 32 and 34 with their respective server side cookie managers 52,62. In one example, the dedicated port is preferably 9102. Dedicated port 70 is necessary to join web server systems 32 and 34, which can be separated by a country or continent. First server side cookie manager 52 maintains data about each web servers 40-44 of systems 32 and 34 for which it monitors network communications. When acting as a root server manager, first server side cookie manager 52 can track the status of each server 40-44 in relation to all other server-side cookie managers, such as server-side cookie manager 62.

Accordingly, server-side cookie managers 52,62 with common cookie database 54 integrate customer tracking across entire web server network 30 while remaining independent of each web server 40-44 within web server network 30 and independent of client computer 20.

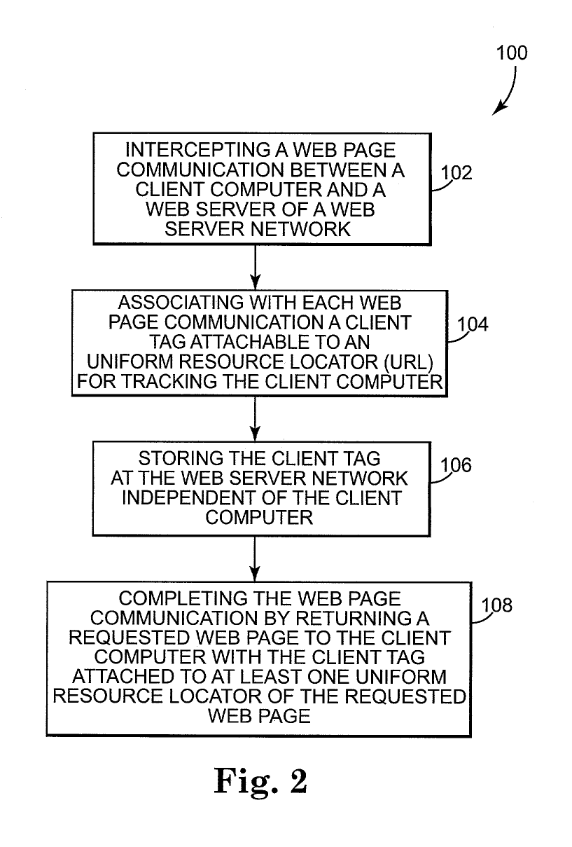

FIG. 2 is a flow diagram illustrating one exemplary embodiment of a method 100 of the present invention for tracking customers across web server network 30. As shown in FIG. 2, method 100 includes a first step 102 of intercepting a web page communication between client computer 20 and web server 40 of web server network 30. The web page communication either is a request from client computer 20 to receive a web page or is a requested web page being sent from a web server, such as web servers 40-44, to client computer 20. Typically, the first intercepted web page request omits any client tag 84 that identifies the customer to web server network 30.

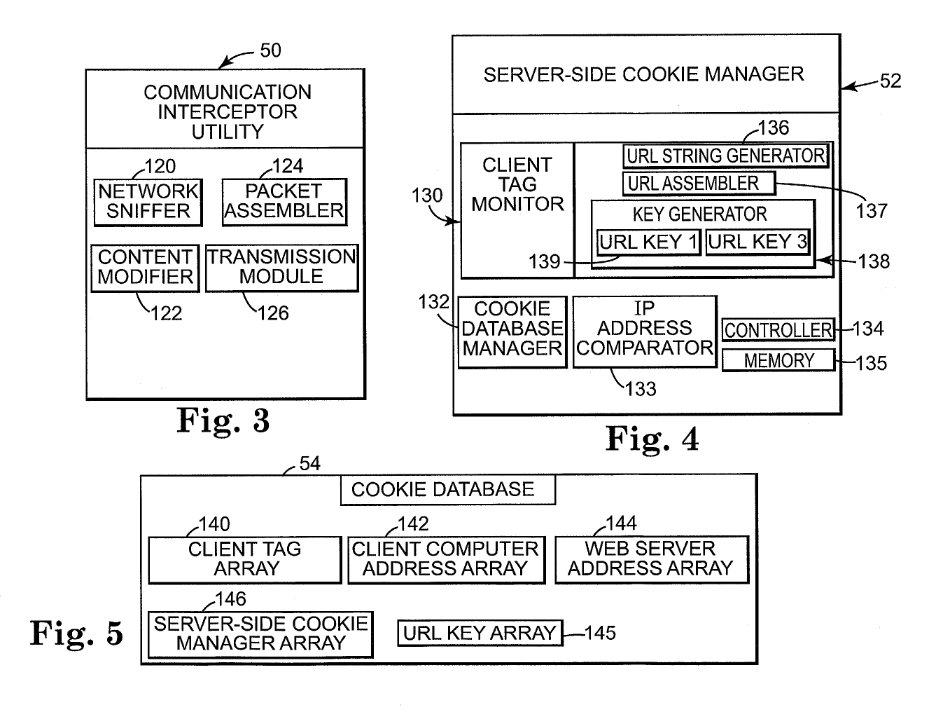

In a next step 104, the intercepted web page communication is associated with a client tag 84 attachable to a uniform resource locator (URL) 82 of a web page within web page communication for tracking client computer 20. This step includes assigning a unique client tag 84 to each client computer 20 for association with the web page communication. Attachment of client tag 84 occurs either in step 104 or a later step such as step 108. Henceforth, each web page sent to client computer 20 from web server network 30 includes client tag 84 attached to every uniform resource locator within the requested web page. Client tag 84 is stored at web server network 30 independent of client computer 20 (step 106). Finally, in a last step 108, the requested web page 80 sent from web server network 30 to the client computer 20 with client tag 84 attached to at least one, and preferably every, uniform resource locator 82 of the requested web page 80. Accordingly, subsequent web page requests to web server network 30 from client computer 20 bear client tag 84 for tracking client computer 20. The components of first customer tracking system 46 and second customer tracking system 48 used in implementing method 100 of the present invention will now be more fully shown and described in association with FIGS. 3-5.

FIG. 3 is a block diagram of communication interceptor utility 50. As shown in FIG. 3, communication interceptor utility 50 includes network sniffer 120, content modifier 122, packet assembler 124, and transmission module 126. Network sniffer 120 identifies communications within a network, such as web server network 30, and isolates selected types of communications by protocol such as hypertext transfer protocol (HTTP), file transfer protocol (FTP), standard mail transmission protocol (SMTP), as well as by address such as IP address, uniform resource locator (URL) addresses, etc., at the discretion of the operator of communication interceptor utility 50. Content modifier 122 analyzes the content of an intercepted communication and is capable of modifying the content of the network communication by addition, deletion, or substitution of the content. Packet assembler 124 disassembles and assembles communication packets, such as those used in Internet communication traffic, allowing a packet to be disassembled for analysis and/or content modification by content modifier 122 and then reassembled. Transmission module 126 generates transmission of network communications, such as packets, and is primarily used for retransmitting an intercepted network communication to its original destination within web server network 30 or to client computer 20 after other portions of communication interceptor utility 50 have inspected and/or manipulated the intercepted network communication.

Communication interceptor utility 50 is preferably provided as software, or firmware from modules such as dsniff, an open source software utility, as well as from modules like Hewlett Packard LAN software analyzer, available from Hewlett-Packard of Palo Alto, Calif. Other known commercially available products also can be used. Communication interceptor utility 50 also optionally includes additional commonly available modules for packet redirection, forging replies, sniffing passwords, saving sniffed files, flooding addresses, capturing mail, capturing chat session messages, terminating or slowing transmission control protocol (TCP) connections, capturing uniform resource locator requests and sniffed uniform resource locators, and sniffing secure socket layer (SSL) communications. Each of these modules are optionally used as necessary depending upon the type of interception and/or manipulation that is desired to be performed on a network page communication within web server network 30.

Accordingly, communication interceptor utility 50 contains all the tools needed to intercept, manipulate, and retransmit a web page communication passing through web server network 30. Communication interceptor utility 50, 60 is disposed and functions so that each network page communication from client computer 20 will be captured before it makes it to web servers 40-44 of web server network 30. This feature alleviates the need to modify any of the web servers 40-44 to implement this method and system of the present invention of tracking customers across web server network 30.

As shown in FIG. 4, server-side cookie manager 52 includes client tag monitor 130, cookie database manager 132, IP address comparator 133, controller 134 and memory 135. Client tag monitor 130 includes uniform resource locator (URL) string generator 136, uniform resource locator (URL) assembler 137, and uniform resource locator (URL) key generator 138.

Server-side cookie manager 52, including controller 134, can be implemented in hardware via a microprocessor, programmable logic device, or state machine, and firmware, or in software within a given device. In one aspect, at least a portion of the software programming is optionally written in Java programming language. Other programming is suitable for use with server-side cookie manager 52 and will be apparent to those skilled in the art.

Controller 134 of server-side cookie manager 52 includes hardware, software, firmware or combination of these. In one preferred embodiment controller 134 includes a computer server or other microprocessor based system capable of performing a sequence and logic operations. In addition, controller 134 can include a microprocessor embedded systems/appliance incorporating tailored appliance hardware and/or dedicated single purpose hardware.

Finally, memory 135 of server-side cookie manager 52 is memory for carrying out operations of components of cookie manager 52 including controller 134.

Client tag monitor 130 of server-side cookie manager 52 generates and tracks client tags for association with client computers such as client computer 20 and requested network pages via uniform resource locators. In particular, uniform resource locator (URL) string generator 136 contains an algorithm to randomly generate an alphanumeric character string to act as a client tag that is suitable for attachment as a string at the end of a uniform resource locator. The uniform resource locator strings comprising client tag 84 preferably are ten characters in length and consist of a combination of letters and numbers following a forward slash, although the string optionally includes exclusively letters, exclusively numbers, or exclusively symbols. For example, client tag 84 could be /1456jh8y0g, which is appended to the end of an URL to appear as http://www.hp.com/go/support/1456jh8y0g. Moreover, strings of characters that are longer or shorter than 10 characters can be used as desirable. When all possible alphanumeric combinations are used up, client tag monitor 130 of server-side cookie manager 52 will re-use prior client tags 84, using those associated with memory resident transactions first.

Uniform resource locator (URL) assembler 138 acts alone, or in combination with components of communication interceptor utility 50, to attach a client tag 84 to an existing uniform resource locator of a web page to form a new uniform resource locator, or to strip a client tag 84 from a uniform resource locator of web page request before the uniform resource locator is acted upon by one of the web servers 40-44.

Uniform resource locator (URL) key generator 139 is employed where the original URL, to which the client tag will be added, is very long and/or complex. In particular, when a requested network page is being returned to client computer 20 and the uniform resource locators in the network page are part of a dynamic application which includes and generates long uniform resource locators, then URL key generator is used to create a URL key 139 that is substituted for the long URL in the web page to represent the long dynamic URL. URL key 139 is preferably an alphanumeric string that replaces a long URL (which includes multiple secondary strings of a uniform resource locator that are directly related to the particular content being requested or presented) by including the web server address and a short single string of characters (e.g. 34g5f)

In user, the long URL is stored in memory 135 and in cookie database 54. URL key 139 replaces the long URLs throughout the web page so that client tag 84 can be readily attached to URL key 139. Later, when a client-tagged URL key 139 of a web page is activated, the communication will be intercepted by communication interceptor utility 50 and with server-side cookie manager 52, URL key 139 is used to access the original long uniform resource locator and rebuild that original uniform resource locator to be sent to the appropriate web server 40-44 to fulfill the web page request.

Finally, server-side cookie manager 52 cooperates with and/or optionally uses components of communication interceptor utility 50 for carrying out its functions.

IP address comparator 133 analyzes client computer addresses 21, in association with cookie database 54, to determine if client computer 20 is recognized in association with an established client tag 84.

As shown in FIG. 5, cookie database 54 includes client tag array 140, client computer address array 142, web server address array 144, URL key array 145, and server-side cookie manager array 146.

Client tag array 140 includes a database array of unique client tags 84 that are associated with addresses 21 of client computers 20 listed within client computer address array 142. Web server address array 144 includes a database array of web server addresses of web server network 30 that are expressed as uniform resource locator addresses. Finally, server-side cookie manager array 146 includes a database array of server-side cookie managers within web server network 30 to permit first server-side cookie manager 52 to determine which other network entities to share information with from server-side cookie database 54. For example, server-side cookie manager array 146 includes a listing of second server-side cookie manager 62 to permit communication through port 70 between the respective server-side cookie managers 52 and 62 and cookie database 54.

Using these tools, server-side cookie database 54 effectively stores all components of server-side cookie transactions (e.g. operations on web page communications), thereby permitting any of the stored information to be parsed for reconstructing any customer transaction within web server network 30.

Moreover, server-side cookie database 54 can be accessed by web servers 40-44 within web server network 30 to match up client-side cookie data (i.e. data regarding cookies stored at a client computer/web browser) at the web server level with data stored in server-side cookie database 54. Accordingly, where information is already known about a customer through their client computer address 21 and client-side cookies, this information can be linked to client tag 84 in server-side cookie database 54. Then, in the future, web servers 40-44 can use client tag 84 in a system and method of the present invention to track that customer while still retaining all prior history of that customer from the previously obtained client-side cookie data. Accordingly, with the system and method of the present invention, a web server of web server network 30 would no longer need to request or use client-side cookies with that customer.

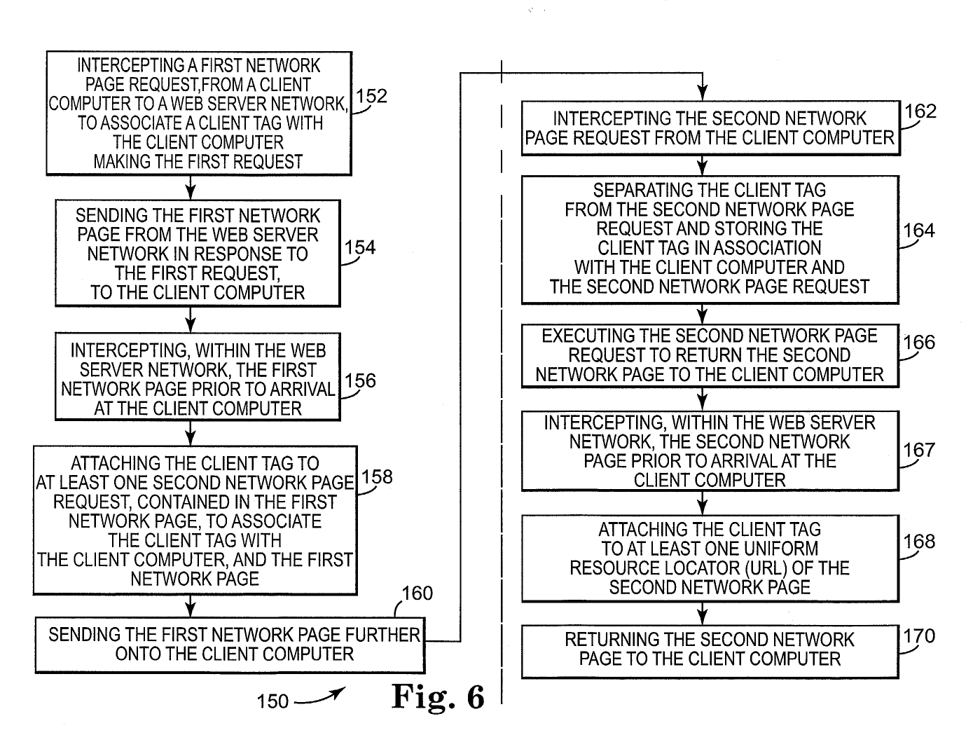

In another exemplary embodiment of the present invention, a method 150 of tracking clients across a web server network is shown in FIG. 6. In a first step of method 150, a first network page request, such as a web page request, is intercepted to associate client tag 84 with client computer 20 making the request. Communication interceptor utility 50 uses network sniffing and other utilities to identify and capture the request. The first network page request is preferably a hypertext link to a web page, such as uniform resource locator http://www.hp.com/go/support, that has been activated by client computer 20.

Communication interceptor utility 50 intercepts the packets, comprising the first network page request, going to web server 40 (or 42,44) and reroutes them to server-side cookie manager 52. Server-side cookie manager 52 first determines the state of the uniform resource locator and identifies that the first network page request is a first request since the uniform resource locator does not include an attached server-side cookie, i.e., client tag 84. Server-side cookie manager 52 then assigns client tag 84 to client computer address 21 and stores the association between client tag 84 and client computer address 21 in temporary memory and/or cookie database 54. The first network page request is then forwarded to web server 40-44 without modification, such as http://www.hp.com/go/support.

In a second step 154, the first network page request is processed at web server network 30, such as one of the web servers 40-44, and then the contents of first network page are sent from the pertinent web server 40-44 to client computer 20. However, in step 156, prior to arrival at the client computer the first network page is again intercepted by communication interceptor utility 50 and re-routed to server-side cookie manager 52 for parsing.

In the next step 158, client tag 84 is attached to at least one, and preferably every, second network page requests within the first network page, to associate client tag 84 with client computer 20 and every second network page request within the first network page. In particular, the first network page includes at least one, and often a plurality of second network page requests, in the form of hypertext link uniform resource locators. Attaching client tag 84 includes attaching client tag 84, an alphanumeric character string, to the end at least one, and preferably every uniform resource locator in the returned first network page.

To attach client tag 84, server-side cookie manager 52 uses IP address comparator 133 to compare client computer address 21 to other client computer addresses 21 stored in memory 135 and/or in client computer address 21 array 142 of cookie database 54, to obtain client tag 84 associated with client computer 20 from client tag array 140. With client tag 84 identified, server-side cookie manager 52 then parses the returned first network page to add client tag 84 to every uniform resource locator within the returned first network page. If one, or all, of the uniform resource locators in the first network page are long and/or dynamic, then server-side cookie manager 52 activates URL key generator 139 to create a unique URL key 139 to act as a link on the first network page in place of each long URL. Client tag 84 is attached to the end of each URL key 139. As previously described in association with FIG. 4, the long URL is stored in cookie database 54 and is recalled later for reconstruction when and if the URL key link is activated by client computer 20 on network page.

After attaching client tag 84 in step 158, step 160 of method 150 includes sending the reconstructed first network page from server-side cookie manager 52 of customer tracking system 46 to client computer 20.

If the user at client computer 20 merely looks at the returned first network page without activating any hypertext uniform resource locators on that page, then the session is terminated. However, the user at client computer 20 frequently activates a hypertext link in first network page, expressed in a uniform resource locator, to request a second network page from one of web servers 40-44 at web server network 30. If this action is taken by client computer 20, then method 150 resumes with step 162, in which the second network page request is intercepted within web server network 30 by communication interceptor utility 50 en route from client computer 20 to web server 40-44 of web server network 30 and re-routed to server-side cookie manager 52 of first customer tracking system 46.

Once at server-side cookie manager 50, step 164 of method 150 first involves separating client tag 84 from the second network page request and storing client tag 84 in memory 135 and/or cookie database 54 in association with client computer address 21 and the second network page request. In particular, where the second network page request is expressed as a uniform resource locator including client tag 84 as part of the uniform resource string, server-side cookie manager 52 strips client tag 84 from the remainder of the uniform resource locator for storage in database 54.

However, in step 164, before client tag 84 is stripped from the URL network page request, server-side cookie manager 52 first determines the state of the URL to see if the URL includes only client tag 84 or includes both client tag 84 and URL key 139. If only client tag 84 is present, then the basic step is followed of stripping client tag 84 from the URL and storing client tag 84 with client computer address 21 for use when the requested network page is returned by web server.

However, if the second network page request (i.e. activated uniform resource locator) includes both client tag 84 and URL key 139, then the full original uniform resource locator associated with URL key 139 is retrieved from cookie database 54 (or optionally from memory 135) and reconstructed without client tag 84 so that the second network page request can be passed on to web server 40-44 handling the request. Of course, the association between client tag 84, the requested second network page, and client computer 20 is maintained in cookie database 54 and/or memory 135.

With client tag 84 stripped from the requested uniform resource locator, and/or the uniform resource locator rebuilt without client tag 84, step 164 is completed by server-side cookie manager 52 sending the second network page request including its reconstructed uniform resource locator onto one of web servers 40-44 within web server network 30.

In step 166, web server 40-44 executes the second network page request and sends the requested second network page back to client computer 20.

However, prior to arrival at the client computer 20, the second network page is again intercepted within web server network 30 by communication interceptor utility 50 for parsing by server-side cookie manager 52 (step 167). Server side cookie manager 52 again identifies the appropriate client tag 84 by looking up the client computer address 21 in cookie database 54 (or optionally from memory 135) and then parses the second network page to add client tag 84 to each uniform resource locator in the second network page. If the URLs are long and/or dynamically-based, then server-side cookie manager 52 employs URL keys 139 in place of the long URL in rebuilding the second network page. As previously explained in association with step 164, the long uniform resource locators are stored in cookie database 54 (or in memory 135) for association with client computer address 21 and client tag 84 for recognition and use upon possible activation of one of the key URLs in second network page.

After the appropriate state of the URLs is determined, step 168 includes attaching client tag 84 to at least one uniform resource locator of the second network page, and preferably attached to every uniform resource locator of the second network page.

Finally, in step 170, the second network page with the added client tags 84 is sent from server-side cookie manager 52 of first customer tracking system 46 to client computer 20.

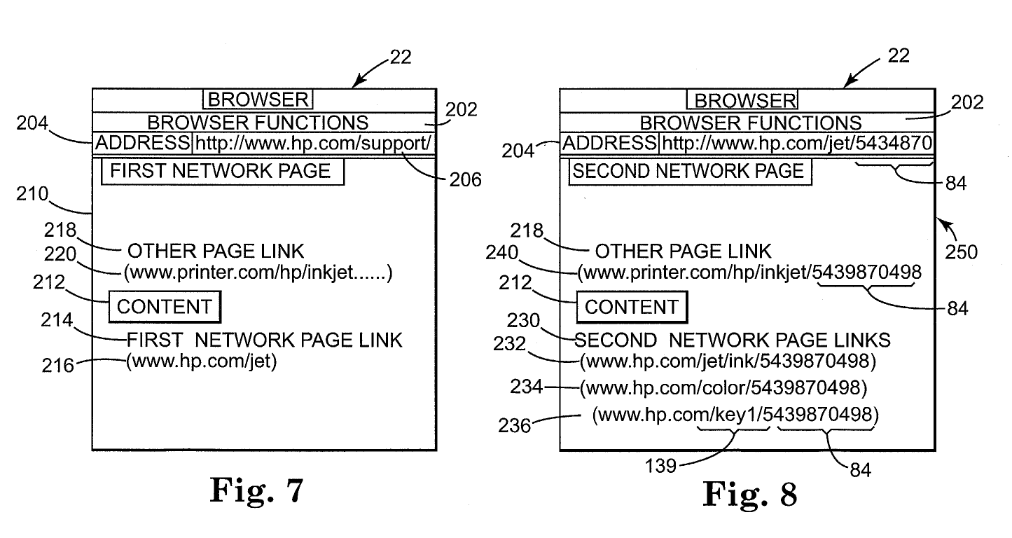

To further illustrate a method and system of the present invention for tracking customers across a web server network, FIG. 7 shows web browser 22 displaying first network page 210 of web server network site 30. As shown in FIG. 7, web browser 22 includes browser functions 202 (e.g., Back, Forward, etc,) address function 204, and first network page 210. Web browser 22 has substantially the same features and attributes as web browser 22, previously described in association with FIG. 1. First network page 210 includes content 212, as well as network page links 214,218 which are activatable links to a plurality of network pages located internally within one of the web servers 40-44 of web server network 30 (FIG. 1). Each link is supported by a uniform resource locator such as first uniform resource locator 216 and second uniform resource locator 220.

Activation of those uniform resource locators 216,220, such as uniform resource locator 216 (e.g., www.hp.com/jet) triggers a request to a web server 40-44 for a second network page, such as second network page shown in FIG. 8. This second network page request is carried out via steps 152 to 160 of method 150 (FIG. 6) of the present invention to produce second network page 250 displayed in web browser 22 in FIG. 8.

In particular, as shown in FIG. 8, second network page 250 includes content 212 along with links 218 and 230. However, every uniform resource locator 232,234,236, and 240 includes client tag 84 (e.g., 5439870498) attached to end of those uniform resource locators. As shown, client tag 84 is preferably a ten character string preceded by a forward slash, and randomly, uniquely generated by server-side cookie manager as previously described in association with FIGS. 1-6. Activating anyone of these uniform resource locators makes another network page request, except now each network page request bears client tag 84 so that web server network 30, via server-side cookie managers 52,62 of customer tracking systems 46,48 recognize client computer 20 without using a client-side cookie stored on client computer 20 or web browser 22.

FIG. 8 also illustrates the use of URL key 139 as shown in uniform resource locator 236, i.e. www.hp.com/key1/5439870498) includes “key 1” as a URL key 139 replacing a previously long dynamic URL string, as previously described in association with FIGS. 2-6.

Finally, the method and system of the present invention is optionally employed in tracking customers that use a file transfer protocol to download information from web server network 30. In particular, first customer tracking system 46 optionally intercepts and manipulates network communications that use the file transfer protocol to attach client tags 84 to an ftp address in the same way that client tags 84 are attached to the end of uniform resource locators of a web page request.

A method and system for monitoring a network site simplifies and enhances network site management. For example, the method and system are effective against anonymous web browsers since client tag 84 is stored in web server network 30 and not at a client computer 20. Moreover, server-side cookie manager 52 is capable of associating a client tag with an anonymous web browser page request since there still are sufficient indicia on anonymous web browsers to make sufficient unique association between client tag and network page request. Moreover, a web page returned from web server network 30 to the anonymous browser includes a client tag attached to each uniform resource locator within requested web page that is displayed on the web browser. Accordingly, subsequent web page requests will still reveal an association between the client tag and the anonymous browser.

For customers, the method and system of the present invention relieves them from regulating acceptance or denial of cookies with web browser cookie sensing. Since a server-side cookie database of the system may include list of accepted uniform resource locators within web server network 30, server-side cookie manager of the customer tracking system can optionally aid the customer by correcting any incorrect uniform resource locators.

For an administrator of web server network, the method and system of the present invention provides centralized tracking of customers regardless of the particular architecture of the web server network while alleviating the need to fight the web browser cookie battle.

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of tracking clients across a web server network comprising:
intercepting, within the web server network, a web page communication between a client computer and a first web server; and
assigning a client tag to the client computer in association with the web page communication; and
storing the client tag independent from the client computer and the first web server.

2. The method of claim 1 and further comprising:
attaching the client tag to the web page communication to track the client computer in association with the web page communication.

3. The method of claim 1 wherein intercepting the web page communication comprises recognizing the web page communication as a first web page request defined by a uniform resource locator, and wherein assigning a client tag comprises selecting at least one uniform resource locator as a portion of the web page communication and attaching the client tag to the at least one uniform resource locator.

4. The method of claim 3 wherein associating with the web page communication comprises:
replacing an extended portion of the uniform resource locator with a key to represent the extended portion of the uniform resource locator and storing the key in memory in association with the extended portion of the uniform resource locator.

5. The method of claim 1 wherein assigning a client tag comprises:
storing the client tag in memory in association with an address of the client computer and the web page communication; and
attaching the client tag to a subsequent web page communication between the client computer and the first web server.

6. The method of claim 1 wherein intercepting web page communications comprises:
sniffing the web page communication within the web server network to identify uniform resource locator addresses of web page requests from the client computer and to identify uniform resource locator addresses of web pages returned to the client computer.

7. A method of tracking clients on a web server network comprising:
intercepting a uniform resource locator request from a client computer to the web server network; and
returning a web page from the web server network to the client computer in response to the uniform resource locator request and including attaching a client tag to each uniform resource locator in the web page;
storing the client tag exclusively within the web server network independent of the client computer.

8. The method of claim 7 wherein storing the client tag comprises:
storing the client tag in a database of the web server network in association with an address of the client computer.

9. A method of tracking clients on a web server network comprising:
intercepting, within the web server network, a first web page request from a client computer to a web server within the web server network;
assigning a client tag to the first web page request and the client computer and storing the client tag in a memory of the web server network;
forwarding the intercepted first web page request to the web server without the client tag;
sending the first web page, with the first web page including at least one activatable second web page request, from the web server to the client computer in response to the first web page request;
intercepting, within the web server network, the first web page prior to arrival at the client computer;
attaching the client tag to the at least one second web page request within the first web page;
storing the client tag in the web server network in association with the client computer and the at least one second web page request; and
sending the first web page on to the client computer.

10. The method of claim 9 and further comprising:
storing the client tag in a database within the web server network in association with an address of the client computer.

11. The method of claim 9 and further comprising:
intercepting, within the web server network, the at least one second web page request from the client computer to the web server network;
removing the attached client tag from the at least one second web page request and storing in a database of the web server network an association between the client computer, the client tag, and the at least one second web page request;
forwarding the second web page request to the first web server and sending a second web page, with the second web page including at least one activatable third web page request, from the first web server to the client computer;
intercepting the second web page prior to arrival at the client computer;
attaching the client tag to at least one third web page request within the second web page and storing in the database an association between an address of the client computer and the client tag; and
returning the second network page to the client computer.

12. The method of claim 9 and further comprising:
providing the first web page request as a uniform resource locator of the first web page of the first web server and providing the second web page request as a uniform resource locator of the second web page of the first web server.

13. A method of processing a web page request comprising:
intercepting a web page request from a client computer to a web server;
assigning a client tag to the client computer and the web page request;
executing the web page request, including tagging every uniform resource locator of the requested web page with the client tag, and returning the requested web page to the client computer; and
recognizing the client computer by the client tag in subsequent uniform resource locator web page requests made by the client computer.

14. A web server network system comprising:
a client computer configured for making a first web page request and for receiving a first web page from a web server;
a web server configured for producing the first web page in response to the first web page request and for sending the first web page to the client computer;
a firewall disposed between the client computer and the web server; and
a customer tracking system disposed between the firewall and the web server and configured for intercepting the first web page request and the first web page to associate a client tag with the first web page and the client computer for recognizing the client computer, in association with the client tag, upon a second web page request made by the client computer from the first web page.

15. The system of claim 14 wherein the customer tracking system is configured for intercepting, between the client computer and the web server, the first web page request and the first web page while in transit and configured for selectively attaching a client tag on each of a plurality of uniform resource locators of the first web page so that upon activation of one of the plurality of uniform resource locators in the first web page by the client computer as a second web page request, the client computer is recognized in association with the client tag and the activated uniform resource locator.

16. A web server network comprising:
at least one web server configured for producing a first web page in response to a first web page request by a client computer; and
a customer tracking system disposed adjacent the at least one web server and configured for intercepting the first web page and attaching a client tag onto every uniform resource locator of the first web page so that upon a second web page request made from the first web page by the client computer, the client computer is recognized in association with the client tag and the second web page request.

17. The network of claim 16 wherein the customer tracking system comprises:
a communication interceptor utility configured to intercept the web page communications and manipulate the network page communications;
a server-side cookie manager configured to associate the client tag with a client computer and the web page communications; and
a database configured to store an association between the client tag, the client computer, and the network page communication.

18. A server side session management system comprising:
a communication interceptor utility configured to intercept a network page communication between a web server network and a client computer and to manipulate the network page communications;
a server-side session manager configured to assign a client tag to a client computer and associate the client tag with the network page communication;
a database configured to store an association between the client tag, the client computer, and the network page communication,
wherein the system is configured for disposition within a web server network.

19. The system of claim 18 wherein the network page communication is at least one of a web page and a web page request including a uniform resource locator for the web page from the web server network and wherein the client tag is an alphanumeric character string configured for attachment to the end of every uniform resource locator address of the requested web page.

20. The system of claim 18 wherein the communication interceptor utility is configured for recognizing a uniform resource locator within a web page communication, intercepting that web page communication, and re-directing that web page communication to the server-side cookie manager.

21. The system of claim 18 wherein the server side cookie manager comprises:
a client tag monitor configured for tracking a plurality of client tags with each client tag in unique association with an address of a client computer and a uniform resource locator of a web page, and configured for generating the client tags as unique alphanumeric character strings for attachment to the uniform resource locator address in the web page; and
a client computer address comparator configured for identifying a client computer address in at least one of the web page and a web page request and for comparing that address with a plurality of client computer addresses stored in a database; and
a cookie database manager in communication with the client tag monitor and the client computer address comparator for storing and retrieving the plurality of client tags and the plurality of client computer addresses in unique association with each other and with a plurality of uniform resource locators of web pages.

22. A server side cookie manager comprising:
a client tag monitor configured for tracking a plurality of client tags with each client tag in unique association with an address of a client computer and a uniform resource locator of a web page, and configured for generating the client tags as unique alphanumeric character strings for attachment to the uniform resource locator address in the web page; and
a client computer address comparator configured for identifying a client computer address in at least one of the web page and a web page request and for comparing that address with a plurality of client computer addresses stored in a database; and
a cookie database manager in communication with the client tag monitor and the client computer address comparator for storing and retrieving the plurality of client tags and the plurality of client computer addresses in unique association with each other and with a plurality of uniform resource locators of web pages.

23. The server-side cookie manager of claim 24 and further comprising:
a uniform resource locator key generator of the client tag monitor configured for creating a uniform resource locator key to represent an extended uniform resource locator of the web page and in communication with the cookie database manager for directing storage and retrieval of the extended uniform resource locator in association with each uniform resource locator key.

24. A server side cookie database comprising:
a client tag array configured for storing and retrieving a plurality of client tags;
a client computer address array configured for storing and retrieving a plurality of client computer addresses in association with the client tags;
a web server address array configured for storing and retrieving a plurality of web server addresses;
a server-side cookie manager array configured for storing and retrieving a plurality of addresses of server-side cookie managers to facilitate recognition and communication between respective server-side cookie managers.

25. A web server network comprising:
a web server configured for producing a first web page in response to a first web page request by a client computer;
means for tracking a customer making the first web page request with the web server disposed adjacent the web server including:
means for intercepting the first web page and the first web page request while in transit between the client computer and the web server; and
means for attaching a client tag to every uniform resource locator of the first web page, prior to arrival at the client computer, so that upon activation of one of the uniform resource locators of the first web page by the client computer, the client computer is recognized in association with the client tag and the activated uniform resource locator.

26. A web server network system comprising:
a client computer;
a web server configured for producing a first web page in response to a first web page request by the client computer;
a firewall disposed between the client computer and the web server;
a customer tracking system disposed between the firewall and the web server including:
a communication interceptor utility configured to intercept the first web page and the first web page request;
a server-side cookie manager configured to associate the client tag with a client computer and the first web page and to attach a client tag to a uniform resource locator of the first web page so that upon activation of the uniform resource locator in a second web page request made by the client computer, the client computer is recognized in association with the client tag and the second web page request.; and
a database configured to store an association between the client tag, the client computer, and the network page communication.

27. A customer tracking system for disposition within a web server network comprising:
a first communication interceptor utility configured to intercept a first web page communication between a client computer and a first web server of a web server network;
a first server-side cookie manager configured to assign a client tag for association with the client computer and the first web page communication;
a cookie database in communication with the first server-side cookie manager and configured to store an association between the client tag, the client computer, and the web page communication;
a second communication interceptor utility configured to intercept a second web page communication between the client computer and a second web server of the web server network;
a second server-side cookie manager configured to assign the client tag for association with the client computer and the second web page communication; and
a communication link between the first and second server-side cookie managers to permit using the client tag to associate the client computer with both of the first web page communication and the second web page communication.

28. A computer-readable medium having computer-executable instructions for performing a method of tracking clients across a web server network, the method comprising:
intercepting, within the web server network, a web page communication between a client computer and a first web server; and
assigning a client tag to the client computer in association with the web page communication; and
storing the client tag independent from the client computer and the first web server.

29. The medium of claim 28 and further comprising:
attaching the client tag to the web page communication to track the client computer in association with the web page communication.

30. The medium of claim 28 wherein intercepting the web page communication comprises recognizing the web page communication as a first web page request defined by a uniform resource locator, and wherein assigning a client tag comprises selecting at least one uniform resource locator as a portion of the web page communication and attaching the client tag to the at least one uniform resource locator.

31. The medium of claim 28 wherein associating with the web page communication comprises:
replacing an extended portion of the uniform resource locator with a key to represent the extended portion of the uniform resource locator and storing the key in memory in association with the extended portion of the uniform resource locator.

32. The medium of claim 31 wherein assigning a client tag comprises:
storing the client tag in memory in association with an address of the client computer and the web page communication; and
attaching the client tag to a subsequent web page communication between the client computer and the first web server.

33. A computer-readable medium having computer-executable instructions for performing a method of tracking clients across a web server network, the method comprising:
intercepting a uniform resource locator request from a client computer to the web server network; and
returning a web page from the web server network to the client computer in response to the uniform resource locator request and including attaching a client tag to each uniform resource locator in the web page; and
storing the client tag exclusively within the web server network independent of the client computer.

34. The medium of claim 37 wherein storing the client tag comprises:
storing the client tag in a database of the web server network in association with an address of the client computer.

35. A computer-readable medium having computer-executable instructions for performing a method of tracking clients across a web server network, the method comprising:
intercepting, within the web server network, a first web page request from a client computer to a web server within the web server network;
assigning a client tag to the first web page request and the client computer and storing the client tag in a memory of the web server network;
forwarding the intercepted first web page request to the web server without the client tag;
sending the first web page, with the first web page including at least one activatable second web page request, from the web server to the client computer in response to the first web page request;
intercepting, within the web server network, the first web page prior to arrival at the client computer;
attaching the client tag to the at least one second web page request within the first web page;
storing the client tag in the web server network in association with the client computer and the at least one second web page request; and
sending the first web page on to the client computer.

36. The medium of claim 35 and further comprising:
storing the client tag in a database within the web server network in association with an address of the client computer.

37. The medium of claim 35 and further comprising:
intercepting, within the web server network, the at least one second web page request from the client computer to the web server network;
removing the attached client tag from the at least one second web page request and storing in a database of the web server network an association between the client computer, the client tag, and the at least one second web page request;
forwarding the second web page request to the first web server and sending a second web page, with the second web page including at least one activatable third web page request, from the first web server to the client computer;
intercepting the second web page prior to arrival at the client computer;
attaching the client tag to at least one third web page request within the second web page and storing in the database an association between an address of the client computer and the client tag; and
returning the second network page to the client computer.

38. The medium of claim 35 and further comprising:
providing the first web page request as a uniform resource locator of the first web page of the first web server and providing the second web page request as a uniform resource locator of a second web page of the first web server.

39. A computer-readable medium having computer-executable instructions for performing a method of processing a web page request, the method comprising:
intercepting a web page request from a client computer to a web server;
assigning a client tag to the client computer and the web page request;
executing the web page request, including tagging every uniform resource locator of the requested web page with the client tag, and returning the requested web page to the client computer; and
recognizing the client computer by the client tag in subsequent uniform resource locator web page requests made by the client computer.
